(19) United States
(12) Patent Application Publication
(10) Pub. No.: US 2013/0030940 A1
(43) Pub. Date: Jan. 31, 2013

(54) BUSINESS MODEL FOR PROVIDING PORTAL SERVICE BASED SERVICE OVERLAY NETWORK

(71) Applicants: Jong-Hwa YI, Daejeon-si (KR); Seung-Ik LEE, Daejeon-si (KR); Shin-Gak KANG, Daejeon-si (KR)

(72) Inventors: Jong-Hwa YI, Daejeon-si (KR); Seung-Ik LEE, Daejeon-si (KR); Shin-Gak KANG, Daejeon-si (KR)

(73) Assignee: Electronics and Telecommunications Research Institute, Daejeon-si (KR)

(21) Appl. No.: 13/534,436

(22) Filed: Jun. 27, 2012

(30) Foreign Application Priority Data
Jul. 29, 2011 (KR) 10-2011-0076113

(51) Int. Cl. G06Q 30/00

(52) U.S. Cl. 705/26.2

(57) ABSTRACT

A service overlay network (SON) service providing apparatus and method are provided. According to an embodiment of the present invention, the SON service providing apparatus is entrusted with element services from an element service provider, sells the entrusted element services to a composite service developer so as to enable the composite service developer to use the element services. In addition, the SON service providing apparatus receives a composite service developed by the composite service developer, and provides the composite service in response to a request from a service user.

### CROSS-REFERENCE TO RELATED APPLICATION

This application claims the benefit under 35 U.S.C. §119(a) of Korean Patent Application No. 10-2011-0076113, filed on Jul. 29, 2011, the entire disclosure of which is incorporated herein by reference for all purposes.

### BACKGROUND

1. Field

The following description relates to a technique for providing services in a service overlay network (SON), and more particularly, to a model and technique for providing portal services in an SON environment.

2. Description of the Related Art

In recent days, a mobile application (app) store type business model is a method of targeting users who purchase applications. According to the mobile app store type business model, when a user pays a price to purchase an application, the price is split among a mobile app store provider and an application developer.

In general, the application developer develops applications that provide predetermined detailed functions using a public interface, that is, open application programming interface (API). However, there are many cases in which the developer is required to additionally develop other functions required for executing other applications. In these cases, the development process becomes complex, and the developer has to have extensive experience and knowledge. For example, when a new game application is to be developed by a developer, a game engine required for executing the game application must also be developed.

When developers develop only new game applications, and additionally required functions such as game engines and the like are provided by other providers, development cost and time are reduced and developers who have new ideas but lack extensive development experience may also easily develop applications for services.

Korean Patent No. 10-0782067 discloses a system and method for user context-based dynamic service composition.

### SUMMARY

The following description relates to a portal service providing business model technology, which is entrusted with an element service from an element service provider, sells the entrusted element service to a composite service developer so as to enable the composite service developer to use the element service, and is entrusted with a composite service developed using the element service purchased by the complex service developer to thereby provide the entrusted complex service to users.

In one general aspect, there is provided a service overlay network (SON) service providing method, including: registering an element service in response to a request for consignment sale made by an element service providing device, and storing element service information; providing the stored element service information in response to a request from a composite service providing device providing a composite service, and providing the element service to the composite service providing device when the composite service providing device requests a purchase; and receiving a composite service manufactured using the provided element service from the composite service providing device to thereby register the received composite service.

In another general aspect, there is provided an SON service providing apparatus, including: an element service information management unit that receives an element service from an element service providing device and manages element service information; and a composite service unit that provides the element service information to a composite service providing device to enable a composite service developer to purchase the element service, and receives a composite service manufactured using the purchased element service from the composite service providing device to thereby provide the received composite service to a service user terminal.

Other features and aspects will be apparent from the following detailed description, the drawings, and the claims.

### BRIEF DESCRIPTION OF THE DRAWINGS

FIG. 1 is a configuration diagram illustrating a service overlay network (SON) service providing system according to an embodiment of the present invention;

FIG. 2 is a detailed configuration diagram illustrating an SON providing device of FIG. 1;

FIG. 3 is a detailed configuration diagram illustrating an element service information management unit of FIG. 2;

FIG. 4 is a detailed configuration diagram illustrating a composite service performance unit of FIG. 2;

FIG. 5 is a flowchart illustrating a process in which an SON provider receives a request for consignment sale of element services to thereby provide the element services to a composite service developer according to an embodiment of the present invention; and

FIG. 6 is a flowchart illustrating a process in which a service user purchases an application provided from an SON provider to thereby use a composite service according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

According to the present invention, an element service provider requests a consignment sale of element services from a service overlay network (hereinafter, referred to as “SON”) provider.

The SON provider manages the element services, and provides the element services to a composite service developer. Next, the composite service developer selects and purchases the element service as needed, and uses the selected and purchased element service. The SON provider is an entrepreneur which operates and manages a composite service app store on an SON.

In addition, according to the present invention, when developing a composite service using the element services, the composite service developer provides an application for the developed composite service to the SON provider.

When a service user purchases the application to use the composite service, the SON provider may search for the element service included in the composite service, and enable the searched element service to be performed, thereby providing the corresponding service to the user.

Hereinafter, configurations and processes of the present invention will be described in detail with reference to the accompanying drawings.

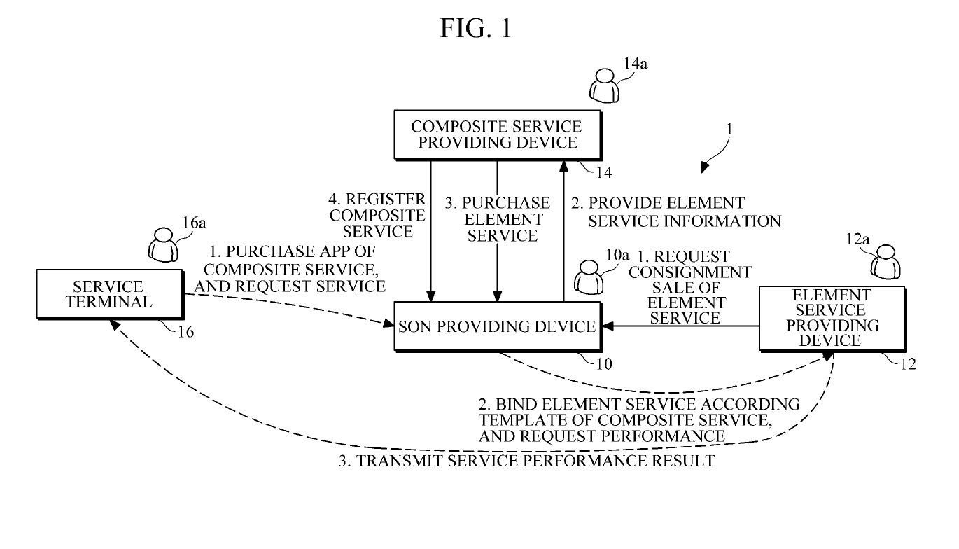

FIG. 1 is a configuration diagram illustrating an SON service providing system 1 according to an embodiment of the present invention.

Referring to FIG. 1, the SON service providing system 1 includes an SON providing device 10, an element service providing device 12, a composite service providing device 14, and a service user terminal 16.

An element service provider 12a registers element services in the SON providing device 10 through the element service providing device 12, and requests a public consignment sale.

The element service is a service which supports a predetermined application function. For example, the element service may be all application services which are currently developed and used such as directions, dictionary, e-mail, English study, photography, search, etc., or to be developed in the future. Here, a plurality of element service providers 12a may be present.

The SON provider 10a manages element service information using the SON providing device 10, and provides the element service information to the composite service providing device 14.

Next, when performance of the composite service is requested by the user terminal 16, the SON provider 10a searches for a corresponding element service, and controls the searched element service to be performed. The element service information includes a service name, provider information, a position of the element service actually performed, a function of the element service, and usage fee information. Here, a plurality of SON providers 10a may be present.

The composite service developer 14a purchases a required element service from the SON providing device 10 using the composite service providing device 14, and develops a new composite service using the purchased element service.

Next, the composite service developer 14a registers the developed new composite service in the SON providing device 100, and enables the composite service to be provided through the SON providing device 100 when the composite service is requested by the user terminal 16. Here, a plurality of composite service developers 14a may be present.

A service user 16a purchases an application of the composite service using the user terminal 16, and uses the composite service through the purchased application.

Below, a process of providing services in an SON will be described in detail with reference to the above-described configurations.

According to an embodiment of the present invention, the SON provider 10a receives a request for consignment sale of element services from the element service provider 12a, and provides the requested element services to the composite service developer 14a.

First, the element service provider 12a registers his own element service in the SON provider 10a so as to exhibit or sell the element service.

Next, the SON provider 10a stores and manages element service information, and provides the element service information to the composite service developer 14a who requests the element service. The element service information includes a service name, provider information, a position of the element service actually performed, a function of the element service, and usage fee information.

Next, the composite service developer 14a selects the element service it requires, and pays the SON provider 10a to purchase the selected element service.

The composite service developer 14a develops a composite service using the purchased element service, and registers the developed composite service in the SON provider 10a. In this instance, the composite service developer 14a also registers template information of the composite service, and the composite service is exhibited to the service user 16a as the SON provider 10a exhibits the composite service in a composite service app store.

The template information includes the element service information to be used, an order of performance, and the like.

According to an embodiment of the present invention, the service user 16a purchases an application through the service app store of the SON provider 10a, and is provided with the composite service.

First, the service user 16a purchases the application of the composite service, and requests the composite service through the application.

The SON provider 10a receives a request from the service user 16a, searches for the corresponding element service from the plurality of element services in accordance with the template of the composite service, and requests performance of the element service from the element service provider 12a. In this instance, when the composite service uses multiple element services, performance of the element services may be repeated in accordance with the template of the composite service.

Next, the SON provider 10a transmits, to the service user 16a, results obtained such that each of the element services is performed.

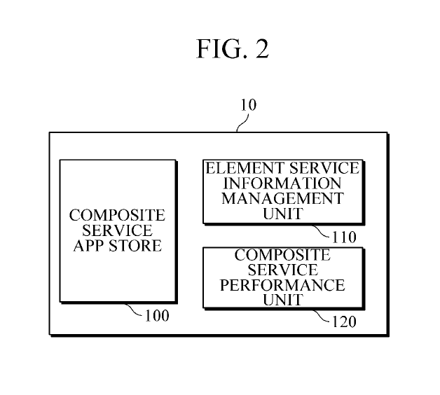

FIG. 2 is a detailed configuration diagram illustrating the SON providing device 10 of FIG. 1.

Referring to FIGS. 1 and 2, the SON providing device 10 includes an element service information management unit 110, and a composite service performance unit 120, and a composite service app store 100.

The element service information management unit 110 receives an element service from the element service providing device 12, and manages element service information.

The element service is a service which supports a predetermined application function.

The element service information includes a service name, provider information, a position of the element service actually performed, a function of the element service, and usage fee information.

The composite service performance unit 120 provides the element service information to the composite service providing device 14 to thereby enable the composite service developer to purchase the element service.

Next, when provision of the composite service is requested by the service user terminal 16, the composite service performance unit 120 searches for the element service associated with the composition service from among the provided element services, and performs the searched element service. The composite service is a service in which a plurality of element services are combined.

The composite service app store 100 receives the composite service from the composite service providing device 14 to store the received composite service, and provides a composite service application to the user terminal 16 at the time of request of the service user 16a.

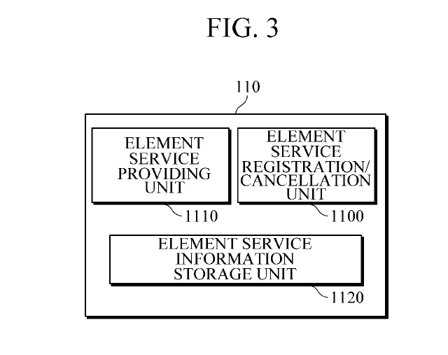

FIG. 3 is a detailed configuration diagram illustrating the element service information management unit 110 of FIG. 2.

Referring to FIGS. 1 and 3, the element service information management unit 110 includes an element service registration/cancelation unit 1100, an element service providing unit 1110, and an element service information storage unit 1120.

The element service registration/cancelation unit 1100 registers or cancels the element service in response to a request from the element service providing device 12.

The element service information storage unit 1120 stores the element service received from the element service providing device 12.

The element service providing unit 1110 provides the element service stored in the element service information storage unit 1120 to the composite service providing device 14.

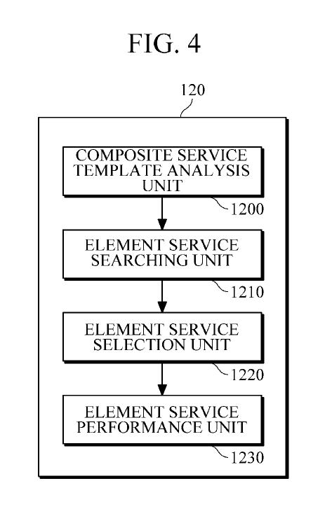

FIG. 4 is a detailed configuration diagram illustrating the composite service performance unit 120 of FIG. 2.

Referring to FIGS. 1 and 4, the composite service performance unit 120 includes a composite service template analysis unit 1200, an element service searching unit 1210, an element service selection unit 1220, and an element service performance unit 1230.

The composite service template analysis unit 1200 analyzes a template of the composite service which is requested by the service user terminal 16.

The element service searching unit 1210 searches for element services in accordance with the template analyzed by the composite service template analysis unit 1200.

The element service selection unit 1220 selects the element services associated with the composite service which is requested by the service user terminal 16, from among the element services searched by the element service searching unit 1210.

The element service performance unit 1230 requests performance of the element service selected by the element service selection unit 1220 from the element service providing device 12, and transmits an element service performance result to the service user terminal 16.

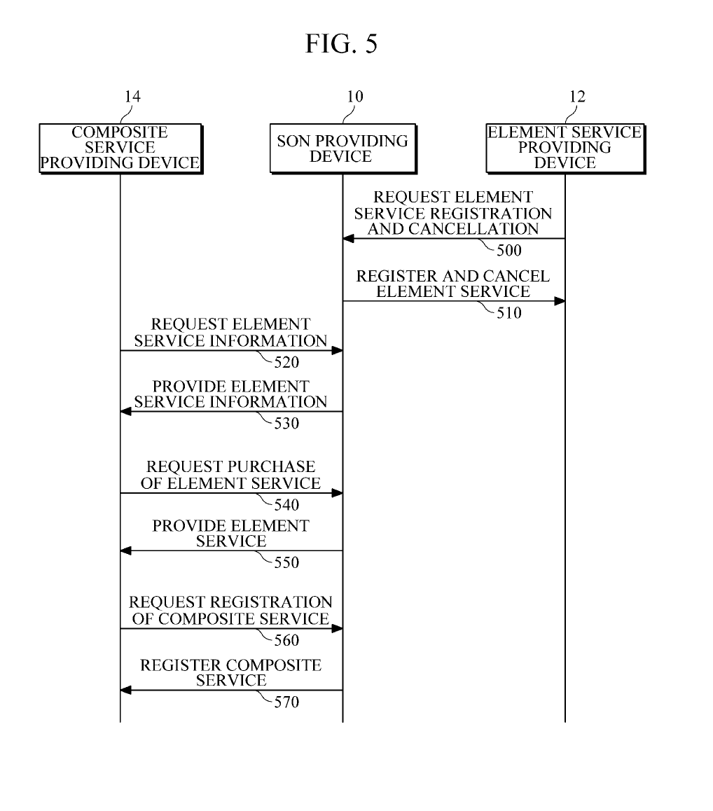

FIG. 5 is a flowchart illustrating a process in which the SON provider receives a request for consignment sale of element services to thereby provide the element services to the composite service developer according to an embodiment of the present invention.

Referring to FIGS. 1 and 5, in step 510, the SON providing device 10 registers services for consignment sale of element services, or cancels the services for termination of the consignment sale, in response to a request 500 for element service registration or cancellation of the element service providing device 12.

Next, in step 530, the SON providing device 10 provides registered element service information in response to a request 520 of the composite service providing device 14.

In step 550, the composite service providing device 14 verifies the provided element service information, and the SON providing device 10 provides the element service when a service purchase is requested in step 540.

Next, when the composite service developer 14a develops a composite service using the provided element service, the composite service providing device 14 requests registration of the developed composite service from the SON providing device 10 in step 560, and the SON providing device 10 registers the composite service in step 570.

The composite service app store 100 exhibits an application of the registered composite service to the service user 16a.

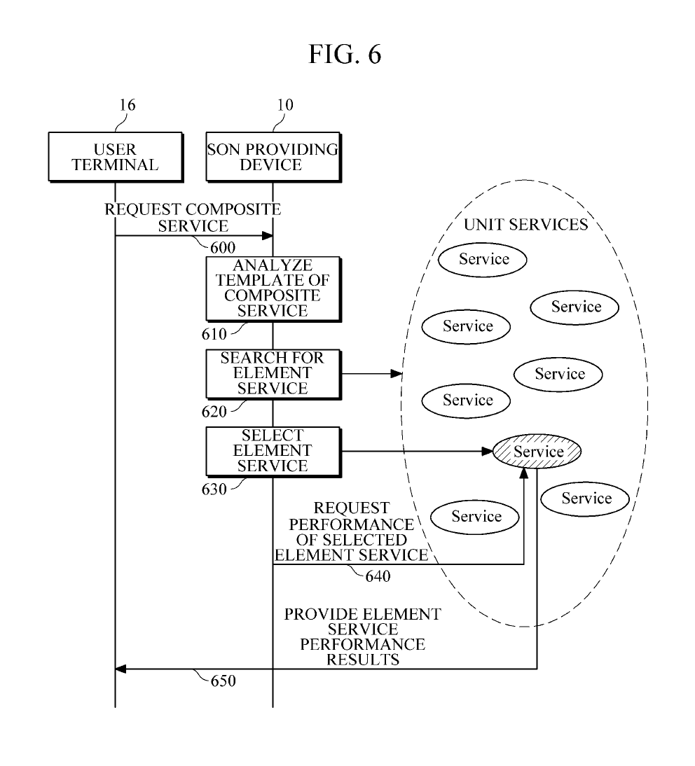

FIG. 6 is a flowchart illustrating a process in which a service user purchases an application provided from an SON provider to thereby use a composite service according to an embodiment of the present invention.

Referring to FIGS. 1 and 6, when the user terminal 16 requests a composite service in step 600, the SON providing device 10 analyzes a template of the composite service in step 610.

The template includes a type of an element service and service related information (that is, requirements for performance).

Next, in step 620, the SON providing device 10 searches for unit services included in the template of the composite service.

In step 630, the SON providing device 10 selects element services suitable for requirements from among the searched element services.

Next, the SON providing device 10 requests performance of the selected element service from the element service providing device 12 in step 640, and transmits an element service performance result to the user terminal 16 in step 650 when the element service providing device 12 performs the element service.

As apparent from the above description, according to the embodiments of the present invention, it is possible to create an expanded business model which enables sale and purchase of services between the element service developer and the composite service developer, from a mobile app store based business through the SON provider. That is, it is possible to create the expanded business model technology which may sell or purchase mutually required services between the element service developer and the composite service developer, by getting rid of a business method of targeting the service user.

Therefore, the SON provider provides, to the composite service developer, the element service whose consignment sale is requested by the element service provider, and the composite service developer purchases required element services, thereby easily and rapidly developing the composite service using the element services purchased by the developer.

In addition, when the composite service developed by the composite service developer is registered, the SON provider may provide the registered composite service to the service user.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A service overlay network (SON) service providing method using an SON service providing apparatus, the method comprising:
registering an element service in response to a request for consignment sale made by an element service providing device, and storing element service information;
providing the stored element service information in response to a request from a composite service providing device providing a composite service, and providing the element service to the composite service providing device when the composite service providing device requests a purchase; and
receiving a composite service manufactured using the provided element service from the composite service providing device to thereby register the received composite service.

2. The SON service providing method according to claim 1, wherein the element service is a service which supports a predetermined application function.

3. The SON service providing method according to claim 1, wherein the composite service is a service which combines a plurality of element services.

4. The SON service providing method according to claim 1, wherein the element service information comprises at least one of a service name, provider information, a position of the element service actually performed, a function of the element service, and usage fee information.

5. The SON service providing method according to claim 1, further comprising:
receiving requests for a purchase of a composite service application and for provision of the composite service from a service user terminal;
searching for the element service associated with the composite service among the element services provided from the element service providing device in accordance with a template of the composite service; and
requesting performance of the searched element service from the element service providing device, and transmitting an element service performance result to the service user terminal.

6. An SON service providing apparatus, comprising:
an element service information management unit that receives an element service from an element service providing device and manages element service information; and
a composite service performance unit that provides the element service information to a composite service providing device to enable a composite service developer to purchase the element service, and receives a composite service manufactured using the purchased element service from the composite service providing device to thereby provide the received composite service to a service user terminal.

7. The SON service providing apparatus according to claim 6, wherein the element service information management unit comprises:
an element service registration/cancellation unit that registers or cancels the element service in response to a request from the element service providing device;
an element service information storage unit that stores the element service received from the element service providing device; and
an element service providing unit that provides the stored element service to the composite service providing device.

8. The SON service providing apparatus according to claim 6, wherein the composite service performance unit controls the element service to be performed in accordance with a template of the composite service when the composite service is requested by the service user terminal.

9. The SON service providing apparatus according to claim 8, wherein the composite service performance unit comprises:
a composite service template analysis unit that analyzes the template of the composite service requested by the service user terminal;
an element service searching unit that searches for the element services in accordance with the analyzed template;
an element service selection unit that selects the element service associated with the composite service requested by the service user terminal from among the searched element services; and
an element service performance unit that requests performance of the selected element service from the element service providing device, and transmits an element service performance result to the service user terminal.

10. The SON service providing apparatus according to claim 8, wherein the composite service performance unit repeats the performance of the element service in accordance with the template of the composite service when the composite service uses a plurality of element services.

11. The SON service providing apparatus according to claim 6, further comprising:
an app store that receives the composite service from the composite service providing device, and provides the received composite service when the composite service is requested by a service user.
